(19) United States
(12) Patent Application Publication
(10) Pub. No.: US 2025/0295270 A1
(43) Pub. Date: Sep. 25, 2025

(54) HANDHELD BLENDER WITH INTERNAL MOTOR UNIT

(71) Applicant: SAMMIC, S.L., Azkoitia (ES)

(72) Inventors: Aitor GOGORZA SEGUROLA, Azkoitia (ES); Gorka USABIAGA ARIZMENDI, Azkoitia (ES); Gorka AGUIRREZABAL OTEIZA, Azkoitia (ES); Carlos BLAZQUEZ BLAZQUEZ, Azkoitia (ES)

(73) Assignee: SAMMIC, S.L., Azkoitia (ES)

(21) Appl. No.: 19/084,397

(22) Filed: Mar. 19, 2025

(30) Foreign Application Priority Data
Mar. 20, 2024 (ES) U 202430544

(51) Int. Cl. A47J 43/08; A47J 43/044; B01F 33/501; B01F 35/32; B01F 35/90; B01F 35/95; B01F 101/00

(52) U.S. Cl. CPC A47J 43/082; A47J 43/044; B01F 33/5011; B01F 35/3204; B01F 35/95; A47J 2043/04427; B01F 2035/98; B01F 2101/1805

(57) ABSTRACT

A handheld mixer comprises a housing, an internal motor unit disposed within the housing, a support plate of an electronic control board disposed within the housing, and at least one heat sink attached to the support plate. The housing comprises an upper air inlet and a lower air outlet. The internal motor unit comprises a lower fan, a brushless motor, a separator bridge, at least one spacer, and a separator cover. The brushless motor is at least partially surrounded by the separator bridge. The separator bridge is linked to the separator cover by the at least one spacer, thereby enabling air to circulate inside the housing through an air chamber.

### CROSS-REFERENCE TO RELATED APPLICATION

This is a US utility application claiming priority under the Paris Convention to the Spanish Utility Model ES U 202430544 filed on Mar. 20, 2024, the content of which is hereby incorporated by reference in its entirety.

### FIELD

This disclosure concerns a handheld mixer with an internal motor unit and a brushless motor of a type that may be used to mix and/or grind food, with an arrangement of elements suitable for working on food.

### BACKGROUND

These days, and as a reference to the state of the art, handheld mixers with an internal motor group, with or without a cable, used to mix and/or grind food, are known.

For the application of these handheld mixers in sectors such as the hospitality industry, where the quantity of food handled is considerably higher, it may be advantageous to have handheld mixers with greater power. Compared to a motor group required for domestic applications, the motor group required for hospitality applications, by requiring greater power, increases both in size and weight, giving rise to very bulky and heavy handheld mixers. Over time, a demand has been generated for increasingly powerful handheld mixers, in order to be able to process larger volumes of food in less time, which leads to a difficult relationship between the weight of the mixer and its power to be considered “handheld”.

In addition, safety problems have been detected in existing models due to the fact that the shredding element, generally in the form of sharp blades, remains in operation for a short period of time after the motor is stopped, due to the inertia of the blades' rotation. There is also a degradation of the internal elements due to the humid environment in which they work, with their control elements not remaining watertight to humidity.

### EXPLANATION OF ILLUSTRATIVE EMBODIMENTS AND ADVANTAGES

In view of this state of affairs, illustrative embodiments refer to a handheld mixer with an internal motor unit consisting of a housing having an upper air inlet and a lower air outlet, in which the motor unit is formed by an exclusive lower fan and a brushless motor partially surrounded by a separator bridge that is linked to the separator cover of the motor unit by means of at least one spacer, allowing air to circulate inside the housing through the air chamber, and on the motor unit there is at least one air heat sink attached to the support plate of the electronic control board.

The use of a brushless motor in handheld mixers, which are those that do not rest on any base to work, allows the generation of greater torque and higher revolutions by having more power compared to a brushed motor, considerably reducing the weight of the mixer body. However, its use requires specific, more complex electronics for its control since in addition to controlling the transmitted intensity as is done in a traditional brushed motor, it is necessary to control the polarity that controls the direction of rotation of the shaft. This difference between a traditional motor and a brushless motor requires the addition of an exclusive electronic control board for the control of the motor and independent of the electronic boards commonly present in handheld mixers, responsible for managing the control of the handheld mixer (transmitting the orders to operate the mixer controls). This electronic control board allows, in addition to a rapid progressive stop, an immediate stop of the motor, short-circuiting the stator phases and generating a braking force in the opposite direction to the rotation, thus eliminating the risk of cutting due to the shredding elements remaining in motion despite a stop order having been given. The addition of another element inside the housing that must house all the elements in the smallest possible space to be manageable and, in addition, the electronic boards being a very sensitive element to the increase in temperature and humidity, generates a need for a different distribution of the elements and which must take into account the saving of space (which induces the grouping of the elements) and the required ventilation (which requires air chambers between the elements), and which is greater the more powerful the motor is and because it has a more complex control board for the brushless motor.

Therefore, in addition to having a greater number of components, on the one hand, the brushless motor requires greater ventilation (due to the increase in power) and on the other hand, the increase in the number of electronic boards by adding the electronic control board requires greater cooling and protection against humidity. Thanks to the placement of an air heat sink linked to the electronic control board and attached to the support plate positioned on the motor unit, that is, at the top when the handheld mixer is in the working or vertical position, correct cooling of the electronic board is guaranteed. A single exclusive lower fan sucks the air from the upper air inlet and expels it through the lower air outlet. By generating an air flow that is contrary to the usual practice of lower air intake and upper outlet, it is possible to work on hot foods that expel steam by absorbing the coldest and least humid air from the upper inlet and cooling first, and with less humidity, the element most sensitive to temperature, which would be the electronic control board through the air heat sink attached to the support plate placed on the motor unit, continuing the circulation of air inside the housing through the air chamber generated by the geometry of the separator cover, slender spacers and separator bridge around the motor unit to cool the brushless motor and, after passing through the exclusive lower fan that would alter the direction of the air flow, expelling the superheated air through the lower air outlet. The expulsion of superheated air at high speed also creates a barrier around the lower air outlets that deflects the upward flow of vapors from the food, creating a space with less humidity that extends to the upper air inlet located higher up (in the vertical or working position), thus allowing the absorption of colder and less humid air from the upper air inlet. This arrangement of the elements also allows the electronic components to be placed in the area furthest from heat and humidity and closest to the control elements, improving cooling, protection against the action of humidity and facilitating the connection of the electronic elements.

An added advantage is that the brushless motor is firmly anchored thanks to the separator bridge assembly, separator cover, and spacer, which, thanks to its configuration, positions it in the center of the housing, but without blocking ventilation due to the cantilever configuration of the separator bridge that surrounds the exclusive lower fan and partially surrounds the motor. The usual movements of handheld mixers (horizontal rest position, vertical working position with possible inclinations with respect to the axis) require that the elements are firmly anchored in order to support the work cycle without movement. In addition, its position in the center of the housing allows, on the one hand, the perfect positioning of the center of gravity of the motor unit (the heaviest component of the mixer) both in a horizontal and vertical position and, on the other, the generation of an air chamber throughout the interior of the mixer and around the brushless motor that allows the correct circulation of air that produces heat dissipation.

The firm anchoring of the motor unit, regardless of the position of the handheld mixer, and the generation of the air chamber is achieved thanks to the fact that the separator bridge comprises at least one transverse support rib and a perimeter seat and flow cavities that allow it to be cantilevered onto the inner walls of the housing.

The position of the support ribs against the housing facilitates the transmission of the weight of the motor unit when the handheld mixer is placed in a horizontal position (at rest), avoiding tension in the anchors. In turn, the perimeter seat allows the weight of the motor unit to be distributed when angular movements are made during work. In addition, as these support elements are not linked to the housing, they can be separated therefrom to carry out maintenance, repair or replacement of parts.

Due to the staggered configuration of the support ribs and the generation of flow cavities, an uninterrupted air chamber is created that allows both the brushless motor and the electronic control board to be cooled by a single air flow. This continuous air chamber surrounds the brushless motor through which the ventilation air circulates in a unified manner, thus being able to effectively cool the brushless motor and allow the movement of the exclusive lower fan by generating the largest possible volume of air chamber around it. This increase in the volume of the air chamber also allows a greater flow of ventilation air, generating optimal cooling of the electronic control board located on the motor unit.

The separator bridge has at least one perimeter seat in which the recess is located that can be used to incorporate the end of the spacer. This allows spacers of various sizes to be incorporated, which allows this configuration to be applied to different modules of greater or lesser length but always ensuring the same location of the brushless motor and the exclusive lower fan in the center of gravity of the handheld mixer body.

Thanks to this configuration of the elements, a secure support of the motor unit that supports the weight of the brushless motor and the correct working position is guaranteed, and the separator cover is linked by means of the spacer element, thus being able to absorb the forces due to the displacement of the center of gravity of the brushless motor produced by the inclinations of the handheld mixer during work. In addition, by centering the support and fixing in a single element, the volume of the air chamber is maximized, allowing a greater flow of ventilation air and therefore better cooling.

In addition, the motor unit separator cover consists of at least one fin and ventilation holes that allow it to rest cantilevered on the inner walls of the housing. Thus, thanks to the cantilevered support of the fin, it allows the transmission of the weight of the motor unit when positioning the handheld mixer in a horizontal position (rest) and the stabilization of the motor unit when angular movements are made during work and the configuration of the fin and ventilation holes allow the fluid and efficient circulation of the ventilation air flow around the entire contour of the brushless motor, allowing perfect cooling of the motor.

The fin has an insertion cavity capable of housing the end of the spacer. This modular configuration of the spacer bridge and the spacer cover, thanks to the fact that the spacer element can be provided in different sizes, makes it possible to adapt the configuration to different sizes of brushless motors and handheld mixers and the use of the same elements for different motors, allowing the standardization of components for a range of handheld mixers with different powers (and different motor sizes).

Additionally, the support plate has a heat sink attached to its ventilated surface and an electronic control board on its sealed surface and has a peripheral projection that can fit into the inner walls of the housing.

Thanks to this configuration, the support plate fits securely into the inner walls of the housing, keeping the elements it contains firmly secured regardless of the position of the handheld mixer, insulated and watertight. In addition, by fitting into the inner walls of the housing, the watertight surface containing the most sensitive electronic elements of the electronic control board is insulated and will not be reached by the humidity from the steam from the food. In this way, the ventilated surface is placed in the most optimal position, close to the upper air inlet, the heat sink being attached to its surface and ensuring contact over its entire surface with the coldest and least humid ventilation air (that received from the outside) and effectively cooling the electronic board to which it is internally connected. They are also covered by a layer of protective resin for greater protection of the electronic elements housed in the ventilated surface.

An added advantage is that the perimeter projection, due to its greater height, allows the addition of a layer of resin up to the edge of the perimeter projection (usually a small amount is applied in the form of varnish), allowing even the most moisture-sensitive elements to be completely covered and protecting them even more from the humid atmosphere of the work environment.

### DRAWINGS AND REFERENCES

In order to better understand the nature of this disclosure, the attached drawings represent an industrial embodiment that is merely illustrative and non-limiting in nature.

FIG. 1 shows a longitudinal section along the axis of the handheld mixer (1) in which the arrangement of the elements can be seen, from top to bottom in a vertical or working position, which would be the electronic control board (6) located at the top together with the other electronic components located on the support plate (5) fitted into the housing (2) from which the heat sink (4) hangs facing the upper air inlets (2a) in an air chamber (2d). Below, in descending order, the separator cover (3e), the spacers (3d), the brushless motor (3b), the separator bridge (3c) and the exclusive lower fan (3a) that make up the motor unit (3) can be seen, with the exclusive lower fan (3a) facing the lower air outlets (2b) and crossed by the shaft (7) that extends along its lower part.

FIG. 2 shows a longitudinal section along the axis in perspective of the handheld mixer (1), wherein the housing (2) and the inner wall of the housing (2d) can be seen, as well as the arrangement of the components. From top to bottom, in a vertical or working position, the components include the electronic control board (6) located at the top alongside other electronic components, positioned on the support plate (5), from which the heat sink (4) is suspended in an air chamber (2d). Below this, the motor assembly (3) is composed of the separator cover (3e), spacers (3d), the brushless motor (3b), the separator bridge (3c), and the exclusive lower fan (3a).

FIG. 3 shows an exploded view of the handheld mixer (1) in which the housing (2) can be seen divided into two parts, showing the inner wall of the housing (2d), the support plate (5) of which the electronic control board (6), the perimeter projection (5c) and the heat sink (4) on its ventilated surface (5a) and the motor unit (3) can be seen on its sealed surface (5b).

FIG. 4 shows an exploded view of the motor unit (3) in which the separator cover (3e) can be seen, on which the fin (3e1) can be observed, in which the insertion cavity (3e1.1) is arranged, the brushless motor (3b) through which the shaft (7) runs, the spacers (3d), the exclusive lower fan (3a) and the separator bridge (3c) composed of the support rib (3c1), the perimeter seat (3c2) in which the insertion cavity (3c2.1) can be observed, the perimeter support (3c3) and the flow cavities (3c4).

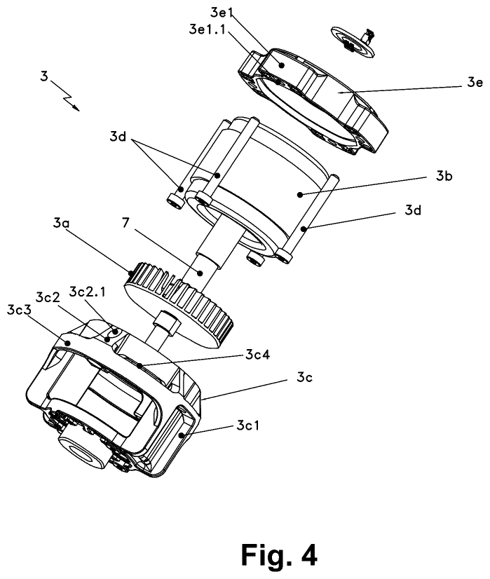

FIG. 5 shows a top view of the separator cover (3e) showing the fins (3e1) and the ventilation cavities (3e2).

The following references are indicated in these figures:
a. Handheld mixer.
b. Housing.
2a. Upper air inlet
2b. Lower air outlet
2c. Inner wall of the housing
2d. Air chamber
3. Motor unit.
3a. Exclusive lower fan
3b. Brushless motor
3c. Separator bridge
   i. 3c1. Support rib
   ii. 3c2. Perimeter seat
   iii. 3c2.1 insertion cavity
   iv. 3c3. Perimeter support
   v. 3c4. Flow cavity
3d. Spacer
3e. Separator cover
   vi. 3e1. Fin
   vii. 3e1.1 Insertion cavity
   viii. 3e2. Ventilation cavities
4. Heat sink
5. Support plate:
5a. Ventilated surface
5b. Sealed surface
5c. Perimeter protrusion
6. Electronic control board
7. Shaft

### Presentation of an Illustrative Embodiment

In relation to the drawings and references listed above, an illustrative mode of execution of the object of this disclosure is illustrated in the attached plans, referring to a handheld mixer (1) with an internal motor unit (3) consisting of a housing (2) that has an upper air inlet (2a) and a lower air outlet (2b) in which the motor unit (3) is formed by an exclusive lower fan (3a) and a brushless motor (3b) partially surrounded by a separator bridge (3c) that is linked to the separator cover (3e) of the motor unit (3) by means of at least one spacer (3d) allowing air circulation inside the housing (2) through the air chamber (2d), and on the motor unit (3) there is at least one air heat sink (4) attached to the support plate (5) of the electronic control board (6).

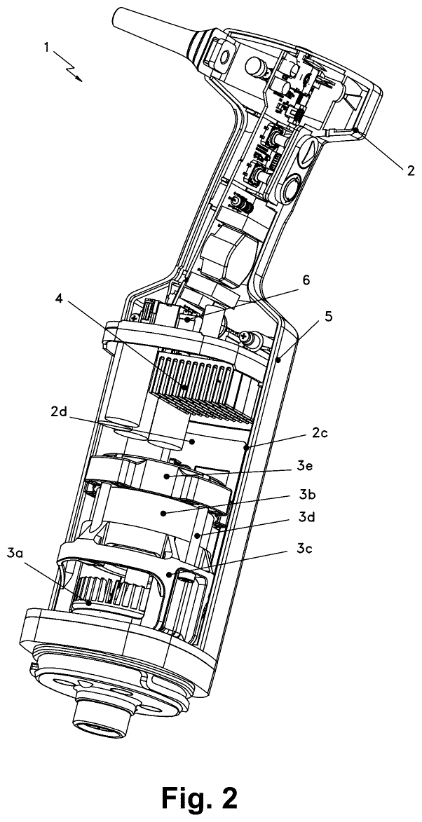

The use of a brushless motor (3b) in the handheld mixer (1) allows the incorporation of a more powerful motor (which generates greater torque and allows it to operate at higher revolutions), considerably reducing the weight of the handheld mixer body (1). The brushless motor (3b) requires the addition of a complex electronic control board (6) for the control of the motor located next to the mixer controls, as can be seen in FIG. 2. This electronic control board (6) allows an immediate stop of the motor by generating a force contrary to the direction of rotation at the moment of stop, so that the residual movement of inertia of the shaft is counteracted, thus eliminating the risk of cutting due to the grinding elements remaining in motion despite having given a stop order. The addition of the electronic control board (6), which is very sensitive to increases in temperature and humidity, inside the housing (2) requires repositioning the elements without increasing the internal volume of the housing (2) and to provide adequate ventilation to all the elements and protection against humidity to the most sensitive electronic elements.

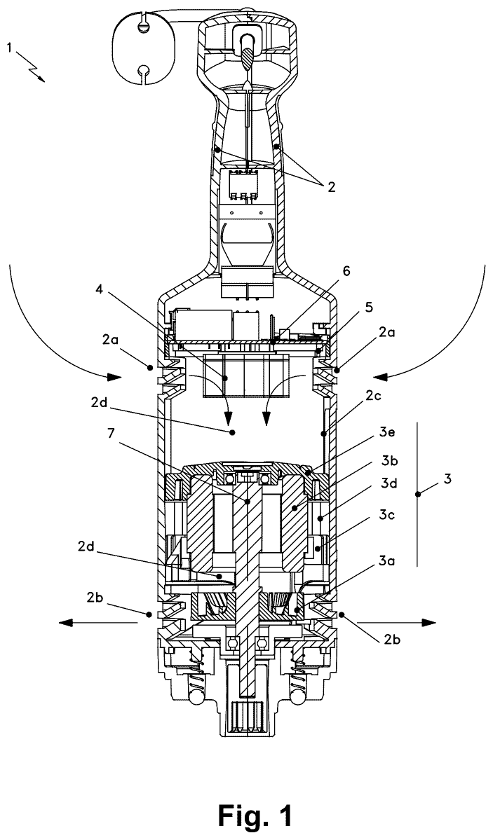

On the one hand, the brushless motor (3b) requires greater ventilation to cool properly (due to the increase in power it generates) and on the other hand, the increase and complexity of the electronic board, by adding the electronic control board (6) requires greater cooling and protection against humidity. To ensure proper cooling of the electronic control board (6), it is placed on the sealed surface of the support plate (5), attached to the ventilated surface (5a) of the support plate (5) and a heat sink (4) linked to the electronic control board (6) is placed thereon. The support plate (5) is placed on the motor unit (3), that is, on the upper part when the handheld mixer is in the working position or vertical position. As can be seen in FIG. 1, at the opposite end, a single exclusive lower fan (3a) is installed that sucks the air from the upper air inlet (2a) and expels it through the lower air outlet (2b). In this way, it is also possible to work on hot foods that expel steam and by absorbing the colder and less humid air from the upper inlet (2a), and cooling first, and with less humidity, the element most sensitive to temperature, which would be the electronic control board (6) through the air heat sink (4) attached to the support plate (5) placed on the motor unit (3), continuing the circulation of air through the interior of the housing (2) through the air chamber (2d) generated by the geometry of the separator cover (3e), spacers (3d) and separator bridge (3c) around the motor unit (3) to cool the brushless motor (3b) and, after passing through the exclusive lower fan (3a), which would alter the direction of the air flow, expelling the superheated air through the lower air outlet (2b). The expulsion of superheated air at high speed also creates a barrier around the lower air outlets (2b) that deflects the upward flow of vapors from the food. This arrangement of the elements also allows the electronic components to be placed in the area furthest from heat and humidity, separated from the rest of the elements by the support plate (5) and closest to the control elements.

The usual movements of handheld mixers (1) (horizontal rest position, vertical working position with possible inclinations with respect to the axis), require that the elements are firmly anchored in order to support the work cycle without movement. For this purpose, the brushless motor (3b), being the heaviest element, is firmly anchored and placed thanks to the separator bridge assembly (3c), separator cover (3e) and the spacer (3d). Thanks to the geometry of the elements, it is positioned in the center of the housing (2), but without blocking the ventilation due to the cantilever configuration of the separator bridge (3c) that surrounds the lower exclusive fan (3a) and partially the brushless motor (3b).

The firm anchoring of the motor unit (3) regardless of the position of the handheld mixer (1) and the generation of the continuous air chamber (2d) is produced thanks to the fact that the separator bridge (3c) consists of an interleaved form with at least one transverse support rib (3c1) and a perimeter seat (3c2) that allow its cantilever support on the inner walls of the housing, and, the flow cavities (3c4) that have been made, which allow an increase in the volume of the air chamber (2d).

The position of the support ribs (3c1) against the inner wall of the housing (2d), allows the transmission of the weight of the motor unit (3) when positioning the handheld mixer (1) in a horizontal position (rest), avoiding tension in the anchors and preventing the generation of slack that would generate vibrations, thereby extending the useful life of the handheld mixer (1). In turn, the perimeter support (3c3) allows the distribution of the weight of the motor unit (3) when angular movements are made during work. On the other hand, as these are support elements, they are not linked to the housing (2), which can be separated to carry out maintenance, repair or replacement of parts.

By the staggered configuration of the support ribs (3c1) and the generation of flow cavities (3c4), a continuous, barrier-free air chamber (2d) is created around the brushless motor (3b) through which the ventilation air circulates in a unified manner, making it possible, thanks to a single air flow, to effectively cool both the electronic control board (6) and the brushless motor (3b). This increase in the volume of the air chamber (2d) also allows for a greater flow of ventilation air, improving the cooling of the electronic control board (6) located on the motor unit (3) (it improves the heat dissipation carried out by the heat sink (4) linked to the electronic control board (6)).

The separator bridge (3c) has at least one perimeter seat (3c2) in which the insertion cavity (3c2.1) is located, capable of incorporating one end of the spacer (3d). This allows for the incorporation of spacers (3d) of various sizes, which allows the same configuration to be applied to different modules of greater or lesser length but always ensuring the same location of the brushless motor (3b).

The brushless motor (3b) is placed supported on and partially surrounded by the separator bridge (3c), guaranteeing a safe support of the brushless motor (3b) and the correct working position. The separator bridge (3c) is linked to the separator cover (3e) by means of the union of preferably four spacer elements (3d), containing the brushless motor (3b) and forming the motor unit (3), thus being able to absorb the forces due to the displacement of the center of gravity of the brushless motor (3b) and compensate it. In addition, by centering the support and the fixing in a single element (the separator bridge element (3c)), the volume of the air chamber is maximized, allowing a greater flow in the ventilation and therefore better cooling by being able to make the motor unit (3) composed of the separator bridge (3c), the separator cover (3e), the spacers (3d), the brushless motor (3b) and the exclusive lower fan (3a) independent of the inner walls of the housing (2c).

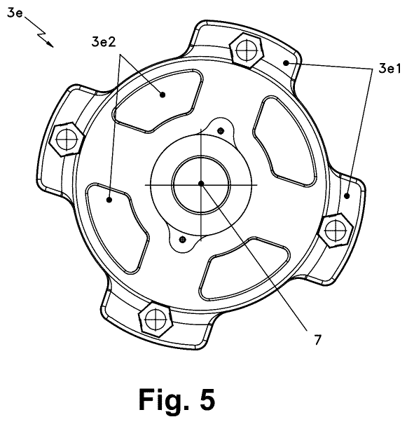

This independence of the inner walls of the housing (2c) from the separator cover (3e) of the motor unit (3) is possible because the separator cover (3e) consists of at least one fin (3e1) which allows it to rest cantilevered on the inner walls of the housing (2c). Thus, thanks to the cantilevered support of the fin (3e1), it is possible to allow balanced transmission of the weight of the motor unit (3) when the handheld mixer (1) is positioned horizontally (at rest) and to stabilize the motor unit (3) when angular movements are made during work. Furthermore, as can be seen in FIG. 5, several ventilation cavities (3e2) are configured in the separator cover (3e), which, together with the separation from the inner walls of the housing (2c) generated by the fins (3e1), allow the fluid and efficient circulation of the ventilation air around the entire contour of the brushless motor (3b), and therefore optimal cooling of the motor, as well as its passage to the lower part of the interior of the housing after cooling the support plate (5).

Individually, each fin (3e1) has an insertion cavity (3e1.1) capable of housing the end of a spacer (3d) that joins the separator cover (3e) with the separator bridge (3c). This modular configuration of the separator bridge (3c) and the separator cover (3e) makes it possible, thanks to the fact that the spacer element (3d) can be provided in different measurements, to adapt the configuration to the different sizes of brushless motor (3b) required for the different handheld mixers (1). This adaptability allows for the standardization of components for a range of handheld mixers with different powers (or different motor sizes) by using the same separator bridge elements (3c) and the separator cover (3e) for different brushless motors (3b) with the modification of the spacer element (3d), this being at a suitable distance from the brushless motor (3b) that integrates the motor unit (3).

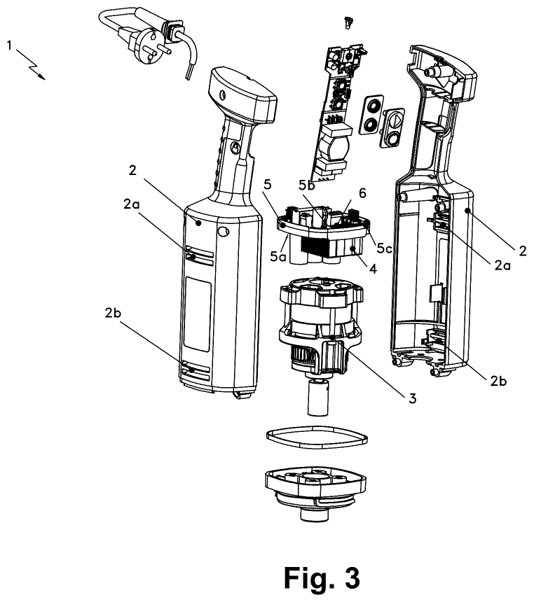

FIG. 3 shows how the support plate (5), located on the motor unit (3) in a vertical or working position, has on its ventilated surface (5a) a heat sink (4) attached to the electronic control board (6) located on its sealed surface (5b) and has a perimeter projection (5c) capable of fitting into the inner walls of the housing (2c).

The support plate (5) fits securely into the inner walls of the housing (2c) around its entire perimeter, keeping the elements it contains firmly secured regardless of the position of the handheld mixer (1). Furthermore, by fitting into the inner walls of the housing (2), insulation is provided for the sealed surface (5b) on which the electronic control board (6) is located (which contains electronic elements sensitive to moisture from food vapor) from the ventilated surface (5a), so that moisture does not reach the sealed surface (5b). Furthermore, the ventilated surface (5a), on which the heat sink (4) is positioned, is located in the most appropriate position for heat dissipation, close to the upper air inlet (2a). By placing the heat sink (4) against the ventilated surface (5a), contact is guaranteed over the entire surface of the heat sink (4) with the coldest and least humid ventilation air (that received from outside through the upper air inlet (2a)) and effectively cools the electronic control board (6) to which it is internally connected. Additionally, the protection of this ventilated surface, and the elements housed therein, is provided for with a layer of resin for greater safety.

The perimeter projection (5c), due to its greater height, allows for the addition of a layer of resin up to the edge of the perimeter projection (a small amount may be applied in the form of varnish) allowing even the most moisture-sensitive elements of the electronic control board (6) located on the sealed surface (5b) of the support plate (5) to be completely covered and protecting them even more from the humid atmosphere of the work environment.

Variations in materials, shape, size and arrangement of the component elements, described in a non-limiting manner, do not alter the essence of this disclosure, this being sufficient for its reproduction by an expert.

What is claimed is:

1. A handheld mixer comprising:
a housing;
an internal motor unit disposed within the housing;
a support plate of an electronic control board disposed within the housing; and
at least one heat sink attached to the support plate;
the housing comprising:
an upper air inlet; and
a lower air outlet, and
the internal motor unit comprising:
a lower fan;
a brushless motor;
a separator bridge;
at least one spacer; and
a separator cover,
wherein the brushless motor is at least partially surrounded by the separator bridge, and
wherein the separator bridge is linked to the separator cover by the at least one spacer, thereby enabling air to circulate inside the housing through an air chamber.

2. The handheld mixer of claim 1, wherein the separator bridge comprises flow cavities interspersed with at least one transverse support rib and a perimeter support capable of being supported on the inner walls of the housing.

3. The handheld mixer of claim 1, wherein the separator bridge comprises at least one perimeter seat defining an insertion cavity capable of incorporating one end of the at least one spacer.

4. The handheld mixer of claim 1, wherein the separator cover comprises one or more ventilation cavities and at least one fin that enable the separator cover to rest cantilevered on the inner walls of the housing.

5. The handheld mixer of claim 4, wherein the at least one fin defines an insertion cavity enabled to house one end of the spacer.

6. The handheld mixer of claim 1, wherein the at least one heat sink heat sink is attached to a ventilated surface of the support plate, and
wherein the electronic control board is disposed on a sealed surface of the support plate and is bordered by a perimeter projection capable of fitting into the inner walls of the housing.
